(19) United States
(12) Patent Application Publication
(10) Pub. No.: US 2013/0219107 A1
(43) Pub. Date: Aug. 22, 2013

(54) WRITE ABORT RECOVERY THROUGH INTERMEDIATE STATE SHIFTING

(71) Applicants: Dana Lee, Saratoga, CA (US); Pao-Ling Koh, Fremont, CA (US); Jianmin Huang, Sunnyvale, CA (US); Gautam A. Dusija, San Jose, CA (US)

(72) Inventors: Dana Lee, Saratoga, CA (US); Pao-Ling Koh, Fremont, CA (US); Jianmin Huang, Sunnyvale, CA (US); Gautam A. Dusija, San Jose, CA (US)

(73) Assignee: SANDISK TECHNOLOGIES INC., Plano, TX (US)

(21) Appl. No.: 13/401,494

(22) Filed: Feb. 21, 2012

(51) Int. Cl. G06F 12/02

(52) U.S. Cl. 711/103; 711/E12.008

(57) ABSTRACT

A memory system or flash card may include a multi-level cell block with multiple states. Before the upper page is written, an intermediate state may be shifted to prevent or minimize overlapping of the states from the corresponding lower page. A write abort during the writing of the upper page will not result in a loss of data from the corresponding lower page.

### TECHNICAL FIELD

This application relates generally to memory devices. More specifically, this application relates to protecting data and improving detection following a write abort in non-volatile semiconductor flash memory.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. During normal host operation, a write abort or erase abort may occur and there is a risk of losing data that was programmed in a previous host command.

For example, binary and Multi-Level Cell (MLC) NAND Flash Memory are forms of non-volatile memory (NVM) that are capable of high data storage densities and high performance, however, a power failure due to hot removal, brownout, blackout or the like may cause data corruption or loss due to the nature of the way in which data is written to this type of memory. Typically a “page” or group of bits at a time is written to the NVM. If a power failure occurs during a write cycle/program operation, something less than all of the bits of the page may be programmed successfully in the NVM. When the page containing unsuccessfully programmed bits is read back, some bits may have the new value, some will have the old value and, as a result, the page may be corrupted.

### SUMMARY

It may be desirable to identify any memory portion that may be partially programmed or partially erased so that steps can be taken to recover the data, and to avoid programming further data in a manner that might cause it to also be corrupted by storing it in partially programmed or partially erased cells. A memory system or flash card may include a multi-level cell block with multiple states and in order to address this problem, an intermediate state may be shifted. In particular, before the upper page is written, an intermediate state may be shifted to prevent or minimize overlapping of the states from the corresponding lower page. A write abort during the writing of the upper page may not result in a loss of data from the corresponding lower page.

According to a first aspect, a flash memory device includes a non-volatile storage having an array of memory blocks storing data. A controller in communication with the non-volatile storage is configured for writing lower page data on a lower page of the non-volatile storage, rewriting the lower page data on the lower page by shifting an intermediate level, and writing to an upper page that corresponds to the lower page after the lower page is rewritten.

According to a second aspect, a memory system comprises a non-volatile storage having an array of memory blocks storing data and a controller in communication with the blocks. The controller is configured to write data to a lower page, shift a verify level of a lower at middle state, rewrite the lower page after the shifting, and write data to an upper page corresponding with the lower page.

According to a third aspect, a method is disclosed for writing to a multiple level cell flash memory in a non-volatile storage device having a controller and blocks of memory. The controller is configured for writing lower page data on a lower page in the memory, rewriting the lower page data on the lower page by shifting an intermediate level, and writing to an upper page that corresponds to the lower page after the lower page is rewritten.

### BRIEF DESCRIPTION OF THE DRAWINGS

FIG. 1 is a block diagram of a host connected with a memory system having non-volatile memory.

FIG. 2 is a block diagram of an exemplary flash memory system controller for use in the system of FIG. 1.

FIG. 3 is a block diagram of an alternative memory communication system.

FIG. 4 is an example physical memory organization of the system of FIG. 1.

FIG. 5 is an expanded view of a portion of the physical memory of FIG. 4.

FIG. 6 is a diagram illustrating charge levels in a multi-level cell memory operated to store two bits of data in a memory cell.

FIG. 7 is a diagram illustrating an intermediate charge state for a multi-level cell.

FIG. 8 is a diagram illustrating the shifting of charge states B and C.

FIG. 9 is a diagram illustrating a shifting of the intermediate state LM.

FIG. 10 is a flow chart illustrating the intermediate state shifting.

FIG. 11 is a flow chart illustrating a recovery of data after an error.

FIG. 12 is a flow chart illustrating the intermediate state shifting.

### BRIEF DESCRIPTION OF THE PRESENTLY PREFERRED EMBODIMENTS

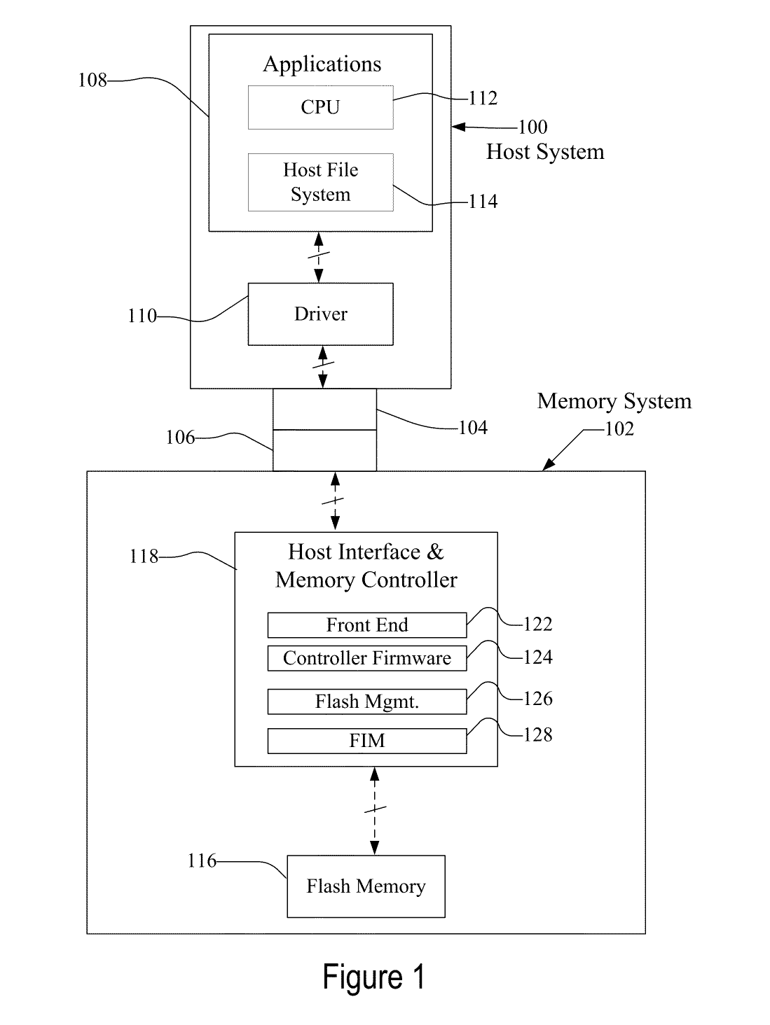

A flash memory system suitable for use in implementing aspects of the invention is shown in FIGS. 1-5. A host system 100 of FIG. 1 stores data into and retrieves data from a flash memory 102. The flash memory may be embedded within the host, such as in the form of a solid state disk (SSD) drive installed in a personal computer. Alternatively, the memory 102 may be in the form of a flash memory card that is removably connected to the host through mating parts 104 and 106 of a mechanical and electrical connector as illustrated in FIG. 1. A flash memory configured for use as an internal or embedded SSD drive may look similar to the schematic of FIG. 1, with one difference being the location of the memory system 102 internal to the host. SSD drives may be in the form of discrete modules that are drop-in replacements for rotating magnetic disk drives.

Examples of commercially available removable flash memory cards include the CompactFlash (CF), the MultiMediaCard (MMC), Secure Digital (SD), miniSD, Memory Stick, SmartMedia, TransFlash, and microSD cards. Although each of these cards may have a unique mechanical and/or electrical interface according to its standardized specifications, the flash memory system included in each may be similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that may use SSDs, memory cards and flash drives are many and varied. They include personal computers (PCs), such as desktop or laptop and other portable computers, tablet computers, cellular telephones, smartphones, personal digital assistants (PDAs), digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip.

The host system 100 of FIG. 1 may be viewed as having two major parts, insofar as the memory 102 is concerned, made up of a combination of circuitry and software. They are an applications portion 108 and a driver portion 110 that interfaces with the memory 102. There may be a central processing unit (CPU) 112 implemented in circuitry and a host file system 114 implemented in hardware. In a PC, for example, the applications portion 108 may include a processor 112 running word processing, graphics, control or other popular application software. In a camera, cellular telephone or other host system 114 that is primarily dedicated to performing a single set of functions, the applications portion 108 includes the software that operates the camera to take and store pictures, the cellular telephone to make and receive calls, and the like.

The memory system 102 of FIG. 1 may include non-volatile memory, such as flash memory 116, and a system controller 118 that both interfaces with the host 100 to which the memory system 102 is connected for passing data back and forth and controls the memory 116. The system controller 118 may convert between logical addresses of data used by the host 100 and physical addresses of the flash memory 116 during data programming and reading. Functionally, the system controller 118 may include a front end 122 that interfaces with the host system, controller logic 124 for coordinating operation of the memory 116, flash management logic 126 for internal memory management operations such as garbage collection, and one or more flash interface modules (FIMs) 128 to provide a communication interface between the controller with the flash memory 116.

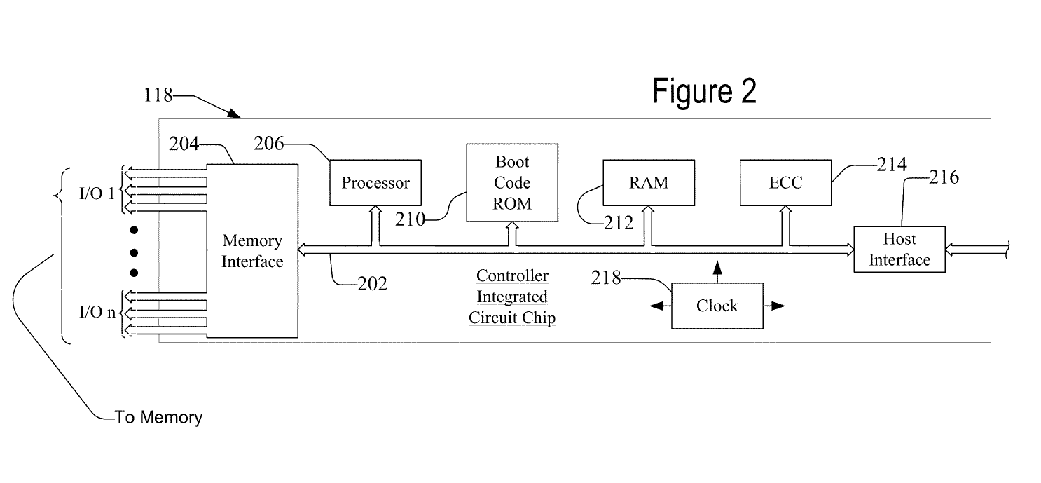

The system controller 118 may be implemented on a single integrated circuit chip, such as an application specific integrated circuit (ASIC) such as shown in FIG. 2. The processor 206 of the system controller 118 may be configured as a multi-thread processor capable of communicating via a memory interface 204 having I/O ports for each memory bank in the flash memory 116. The system controller 118 may include an internal clock 218. The processor 206 communicates with an error correction code (ECC) module 214, a RAM buffer 212, a host interface 216, and boot code ROM 210 via an internal data bus 202.

The ROM 210 may be used to initialize a memory system 102, such as a flash memory device. The memory system 102 that is initialized may be referred to as a card. The ROM 210 in FIG. 2 may be a region of read only memory whose purpose is to provide boot code to the RAM for processing a program, such as the initialization and booting of the memory system 102. The ROM may be present in the ASIC rather than the flash memory chip.

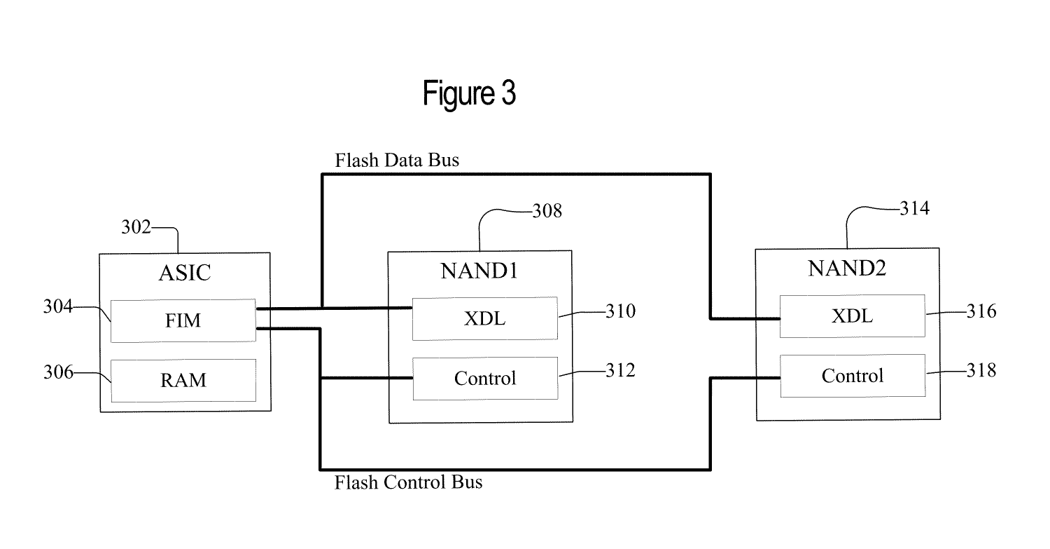

FIG. 3 is a block diagram of an alternative memory communication system. An application-specific integrated circuit (ASIC) 302 may include a flash interface module (FIM) 304 and random access memory (RAM) 306. The ASIC 302 may be a chip that communicates with multiple flash memory modules or devices, such as NANDs 308, 314. The FIM 304 communicates data over the flash data bus and communicates control commands over the flash control bus. The NAND1 308 and NAND2 314 are types of flash memory that receive commands and data from the FIM 304 of the ASIC 302. Each of the NAND1 308 and NAND2 314 include controls 312, 318, respectively, for receiving control signals from the ASIC 302. Likewise, each of the NAND1 308 and NAND2 314 include an eXternal Data Latch (XDL) 310, 316, respectively, for receiving data signals from the ASIC 302. Although the flash data bus and flash control bus are illustrated as separate busses that communicate with the XDL 310, 316 and Control 312, 318 of the respective NANDs 308, 314, there may be a singular bus for communication.

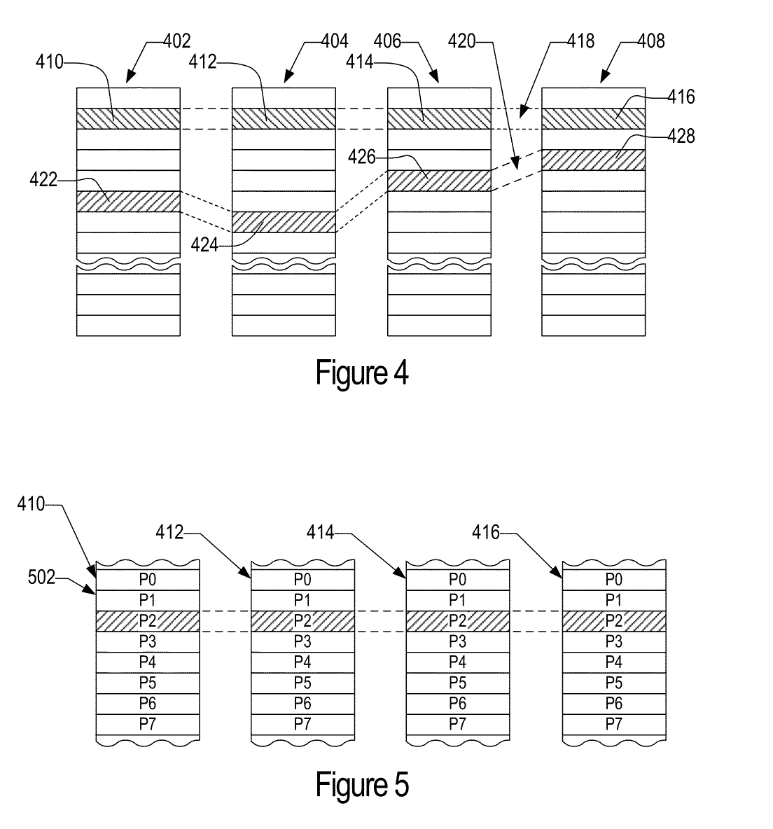

FIG. 4 conceptually illustrates an organization of the flash memory 116 (FIG. 1) as a cell array. Certain blocks or cell arrays may be safe zone blocks (SZB) for storing data that is written to predetermined risk zones as described below. The flash memory 116 may include multiple memory cell arrays which are each separately controlled by a single or multiple memory controllers 118. Four planes or sub-arrays 402, 404, 406, and 408 of memory cells may be on a single integrated memory cell chip, on two chips (two of the planes on each chip) or on four separate chips. The specific arrangement is not important to the discussion below. Of course, other numbers of planes, such as 1, 2, 8, 16 or more may exist in a system. The planes are individually divided into groups of memory cells that form the minimum unit of erase, hereinafter referred to as blocks. Blocks of memory cells are shown in FIG. 4 by rectangles, such as blocks 410, 412, 414, and 416, located in respective planes 402, 404, 406, and 408. There can be any number of blocks in each plane. Certain blocks may be reserved as safe zone blocks (SZBs) that are protected blocks for protecting data that is written to predetermined risk zones, such as a lower page.

As mentioned above, the block of memory cells is the unit of erase, the smallest number of memory cells that are physically erasable together. For increased parallelism, however, the blocks may be operated in larger metablock units. One block from each plane is logically linked together to form a metablock. The four blocks 410, 412, 414, and 416 are shown to form one metablock 418. In one embodiment, the SZB is one or more metablocks. All of the cells within a metablock are typically erased together. The blocks used to form a metablock need not be restricted to the same relative locations within their respective planes, as is shown in a second metablock 420 made up of blocks 422, 424, 426, and 428. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

The individual blocks are in turn divided for operational purposes into pages of memory cells, as illustrated in FIG. 5. The memory cells of each of the blocks 410, 412, 414, and 416, for example, are each divided into eight pages P0-P7. Alternatively, there may be 16, 32 or more pages of memory cells within each block. The page is the unit of data programming and reading within a block, containing the minimum amount of data that are programmed or read at one time. However, in order to increase the memory system operational parallelism, such pages within two or more blocks may be logically linked into metapages. A metapage 502 is illustrated in FIG. 4, being formed of one physical page from each of the four blocks 410, 412, 414, and 416. The metapage 502, for example, includes the page P2 in each of the four blocks but the pages of a metapage need not necessarily have the same relative position within each of the blocks. A metapage may be the maximum unit of programming.

The memory cells may be operated to store two levels of charge so that a single bit of data is stored in each cell. This is typically referred to as a binary or single level cell (SLC) memory. Alternatively, the memory cells may be operated to store more than two detectable levels of charge in each charge storage element or region, thereby to store more than one bit of data in each. This latter configuration is referred to as multi level cell (MLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material.

In implementations of MLC memory operated to store two bits of data in each memory cell, each memory cell is configured to store four levels of charge corresponding to values of “11,” “01,” “10,” and “00.” Each bit of the two bits of data may represent a page bit of a lower page or a page bit of an upper page, where the lower page and upper page span across a series of memory cells sharing a common word line. Typically, the less significant bit of the two bits of data represents a page bit of a lower page and the more significant bit of the two bits of data represents a page bit of an upper page.

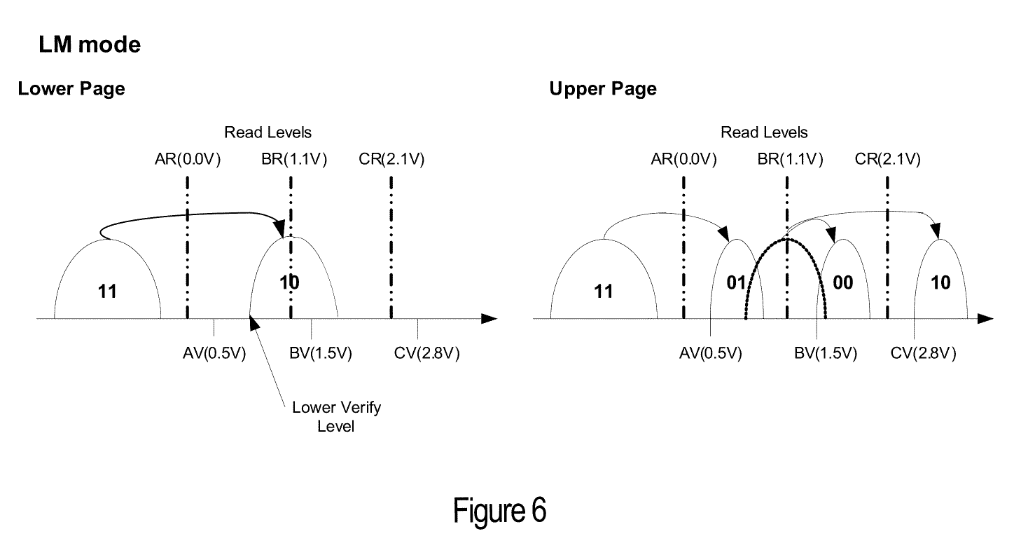

FIG. 6 illustrates one implementation of the four charge levels used to represent two bits of data in a memory cell. FIG. 6 is labeled as LM mode which may be referred to as lower at middle mode and will further be described below regarding the lower at middle or lower-middle intermediate state. The LM intermediate state may also be referred to as a lower page programmed stage. A value of “11” corresponds to an un-programmed state of the memory cell. When programming pulses are applied to the memory cell to program a page bit of the lower page, the level of charge is increased to represent a value of “10” corresponding to a programmed state of the page bit of the lower page. The lower page may be considered a logical concept that represents a location on a multi-level cell (MLC). If the MLC is two bits per cell, a logical page may include all the least significant bits of the cells on the wordline that are grouped together. In other words, the lower page is the least significant bits.

For a page bit of an upper page, when the page bit of the lower page is programmed (a value of “10”), programming pulses are applied to the memory cell for the page bit of the upper page to increase the level of charge to correspond to a value of “00” or “10” depending on the desired value of the page bit of the upper page. However, if the page bit of the lower page is not programmed such that the memory cell is in an un-programmed state (a value of “11”), applying programming pulses to the memory cell to program the page bit of the upper page increases the level of charge to represent a value of “01” corresponding to a programmed state of the page bit of the upper page.

MLC storage may be subject to lost data in the event of a write abort. Improved mechanisms are disclosed for guaranteeing that pages during previous write-sequences are recoverable even in the event of a power-interruption. When writing an upper page over a previously written lower page there may be a period where the lower-page is not recoverable.

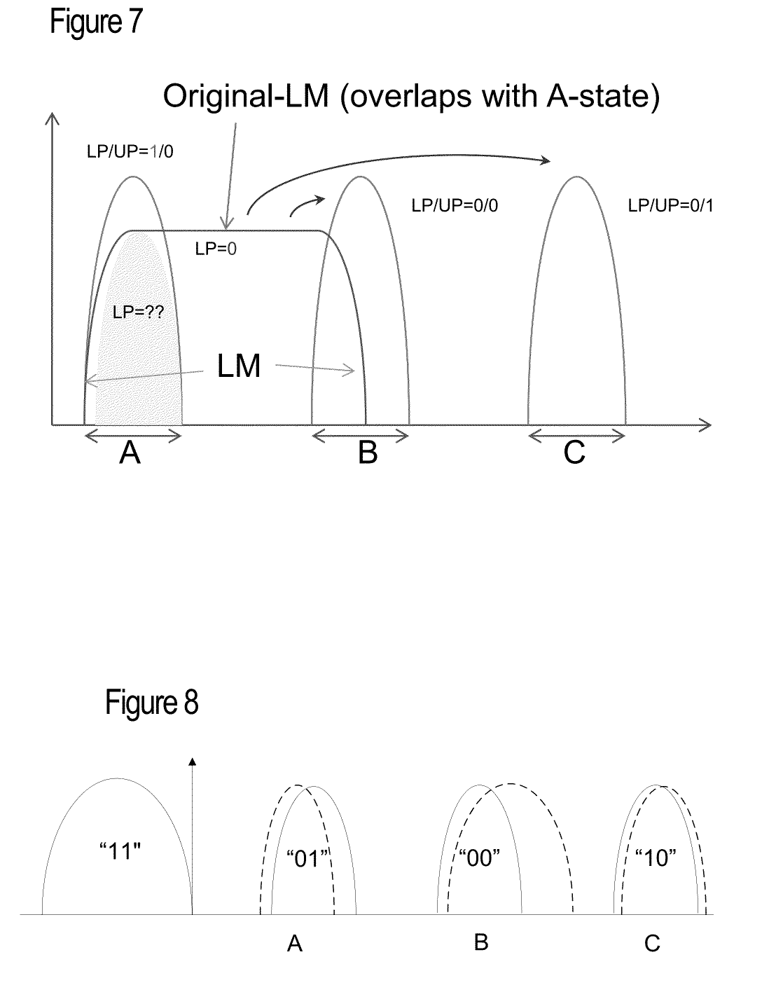

FIG. 7 is a diagram illustrating an intermediate charge state for a multi-level cell (MLC). In particular, FIG. 7 is a graphical representation of the bit or cells in a word line. The left boundary of states A, B, and C in FIG. 7 are the verify levels or voltages shown in FIG. 6 as AV, BV, and CV, respectively. The voltage values AV, BV, and CV are the respective voltage values for transitioning between states. FIG. 7 includes an intermediate state, which may be referred to as the lower at middle state, or the LM state.

The LM state is an intermediate state before programming the upper state. The intermediate or LM state may be where the lower page would reside when the lower page is first programmed. The B and C states may be programmed from the intermediate state. When the upper page is programmed, the original LM may be converted to become state B and/or state C.

The LM state is shown as overlapping with state A, in which case the lower page data may be indeterminate in the range in which the LM state overlaps the A state. The illustrated overlap may result from the programming of the upper page. When states A and LM overlap, the lower page data may be indeterminate and not safe from write abort. As discussed below a smaller or reduced overlap between the states may result in the data being safe, but an overlap as in FIG. 7 may result in the lower page data being unrecoverable if there is a write abort. In particular, if the overlap between A and LM is large, then it is indeterminate and the lower page may be corrupted. As shown, the lower page (LP) is equal to zero for state LM. The lower page/upper page value at state B is 0/0 and the lower page/upper page value at state C is 0/1. At state A, the lower page/upper page value is 1/0. Conversely, the original LM has a lower page value of zero. Accordingly, at the overlap between A (lower page value=1) and LM (lower page value=0), the value of the lower page cannot be determined. As described below, a shifting of the LM state may remove or reduce the overlap.

In one embodiment, the B and C states may be written first before programming or erasing state A. The intermediate state LM is only programmed to states B or C. After programming states B and C state A may then be programmed. By programming LM into states B and/or C first before state A, the overlap between state A and LM may be reduced or eliminated. This embodiment may be referred to as BC-first programming. There may be a performance penalty from programming states B and C first. State B may be subject to the coupling effects (which may be referred to as a Yupin effect) when state A is programmed. Further, the BC-first programming may result in a wider B state and upshifting of the C state. These changes may need to be corrected (reshifted or re-leveled).

The coupling effects result in a modification of a state when a nearby state is programmed. One set of cells is programmed to add a level of charge to their floating gates that corresponds to one set of data. After the second set of cells is programmed with a second set of data, the charge levels read from the floating gates of the first set of cells may appear to be different than programmed because of the coupling effect caused by the charge on the second set of floating gates being coupled with the first.

FIG. 8 is a diagram illustrating the shifting of charge states B and C. In particular, the B state may be widened and the C state is upshifted. The solid line illustrates normal positions for the A, B, and C states. The dotted lines illustrate the resultant positions of the states when the B and C states are programmed first before the A state.

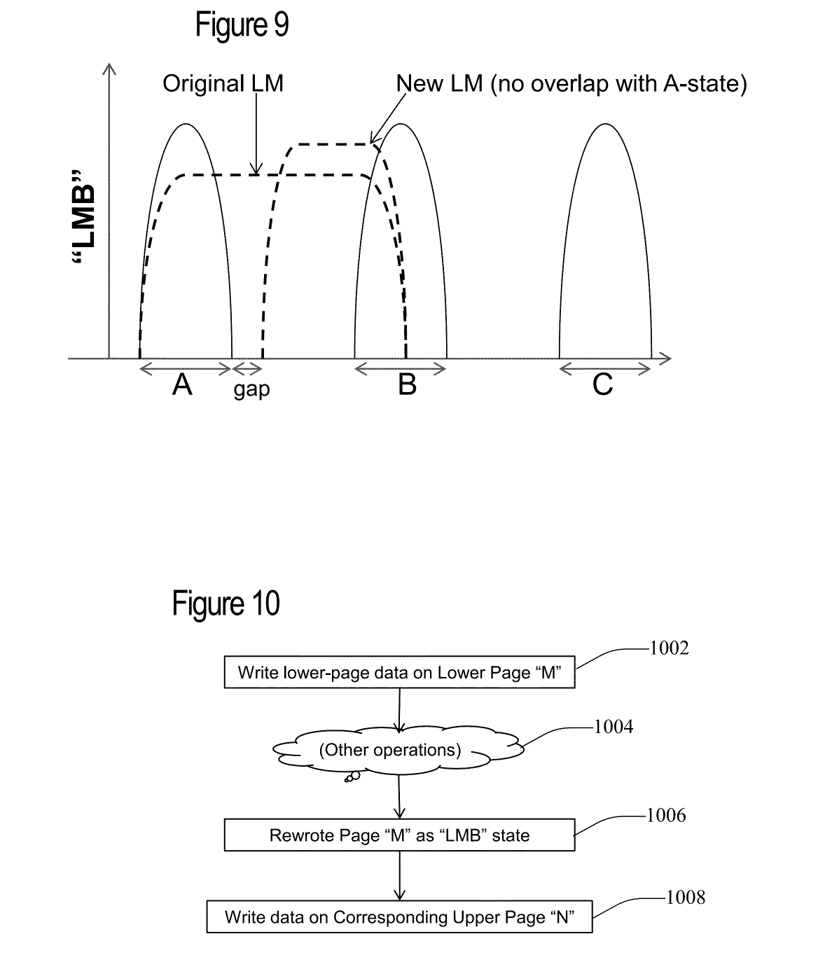

FIG. 9 is a diagram illustrating a shifting of the intermediate state LM. The shifted state of the intermediate or lower at middle (LM) state may be referred to as LMB or the lower-middle state. LMB programming may occur when the LM data is programmed to a level similar to the B state level. The original LM state is shown as overlapping with the A state. The new LM or LMB state is shown with its verify level (left side of the distribution) shifted up past the A state. FIG. 9 illustrates a gap between the A state and the new LM state. In alternative embodiments, there may be an overlap between the new LM state and the final A state.

In one embodiment, the LM state may be shifted before the upper page writing starts. The shift of the LM state may eliminate or reduce the overlap between the LM intermediate state and the A state as shown in FIG. 9. The LM state shift may not degrade endurance and may result in the same distribution as the normal program. In other words, the resulting states are the same or similar and do not require shifting or leveling. Conversely, the resulting states shown in FIG. 8 (i.e. the dotted line states) were shifted from their original states. The verify level for the LM state may be moved from state A to eliminate or reduce the overlap of the LM state with the state A.

FIG. 9 illustrates the shifting of the LM state so that the verify level or boundary point no longer overlaps with the A state. In alternative embodiments, the LM state may maintain an overlap with the A state, but the overlap is reduced so that the indeterminate area is substantially reduced. Such a choice may achieve higher-performance operation as compared to an embodiment which features no overlap. When the overlap is reduced or small, the error correction code (“ECC”) may be able to detect that smaller amount and correct for any conflicts. When a write abort occurs and the LM state has been shifted, the data may be recoverable when there are no bits in the overlap or the overlap is small enough that the data can be distinguished and recovered. When the area of overlap is small, there may be fewer bits in error. In particular, overlap may be acceptable as long as the data can be read and the ECC engine can correct the cell. For example, if the ECC engine is 122 bits and as long as the overlap is less than those, it may be possible to distinguish the data despite the slight overlap. The location of the minimal overlap region may be a function of the point in time where a write-abort occurs. At all points in time, the minimum overlap region can be corrected, but due to the unpredictable nature of the write-abort timing, the location of the minimal overlap region may be unknown. Therefore it may be necessary to use a dynamic-read mechanism to scan for the location of the minimal overlap.

The NAND memory may include a spare area for extra storage on each page that may be used for storing ECC code as well as other metadata. ECC may be performed in hardware or software. During a programming operation, the ECC unit may calculate an ECC code based on the data stored in the sector. The ECC code for the data area may be written to the corresponding spare area. When the data is read out, the ECC code may also be read out, and the reverse operation may be applied to check that the data is correct. The ECC algorithm may correct data errors and may depend on a correction strength of the algorithm used.

Shifting of the LM state may still allow using NAND cache programming. Conversely, the BC-first implementation may prevent using NAND cache programming. Utilizing a write cache may result in faster and more efficient processing. In other embodiments, the memory may include single level cell and different types of memory, such as Random Access Memory. Without the cache, the next page of the NAND program would not start until the data was transferred. However, when using a write cache, the data for the next page can be transferred in parallel with the programming on the current page. After the NAND releases its data at certain levels and then once data is sent to the NAND, it starts the next program. Accordingly, the gap between NAND programming is reduced. Further, the timing of the LM state shifting may be carried out without clocking in the upper page data. It may start as a background operation before or while the upper page is loaded.

FIG. 10 is a flow chart illustrating the intermediate state shifting. For a corresponding lower page and upper page, the data for the lower page may be written first. In block 1002, the lower page data is written to lower page M. There may be other operations performed in block 1004, which are performed before the upper page is then written. In block 1006, the intermediate LM state is shifted before the upper page is written. In particular, page M is rewritten with the LM state shifted as shown in FIG. 9. In block 1008, the data can be written on the corresponding upper page N. In other words, page M is the lower page that corresponds with upper page N. FIG. 10 illustrates that page M is rewritten with the intermediate LM state shifted before the corresponding upper page is written. In this case, a write abort for the upper page may not result in the lower page being lost. The lower page may be recovered even if the operation is aborted.

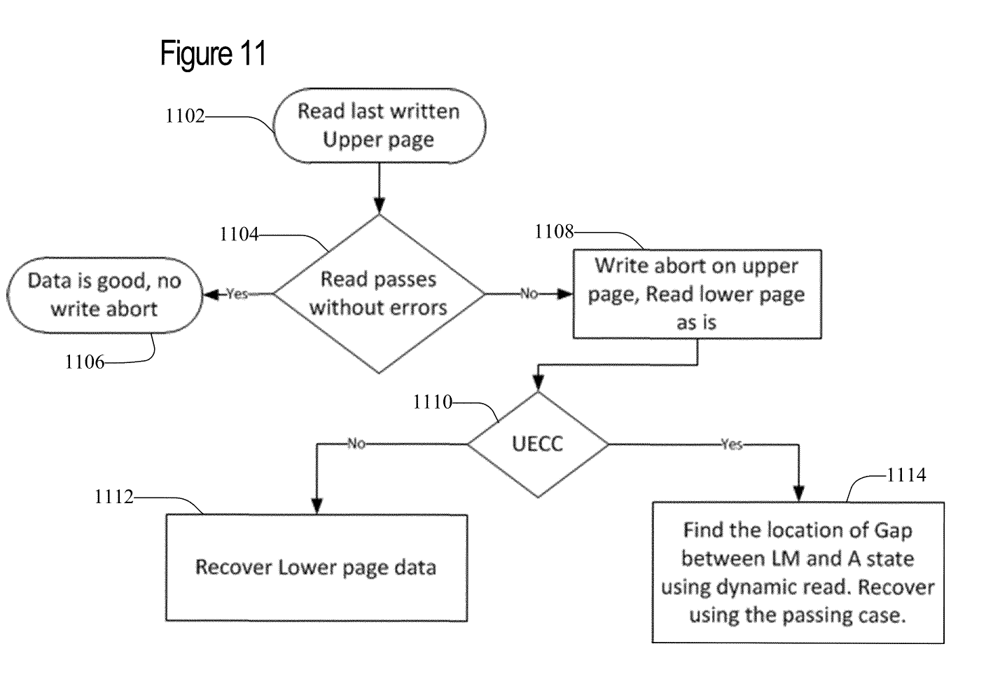

FIG. 11 is a flow chart illustrating a recovery of data after an error. In block 1102, the last written upper page is read. In block 1104, if the read passes without errors, then the data is good and there was no write abort as in block 1106. In block 1104, if the read does not pass without errors, then there was a write abort on the upper page and the lower page is read as is in block 1108. In block 1110, the uncorrectable error correction code (“UECC”) is run for the lower page. In block 1112, the lower page data is recovered if there is no UECC. In block 1114, the location of the gap between the LM and A state is found using dynamic read. Identification of the gap between the LM state and the A state may be used for determining the value of the lower page. In alternative embodiments, the dynamic read scanning may be implemented by the controller using UECC based criteria or it could be performed “on-chip” using gap detection techniques.

Dynamic read may include the ability to read the cell at different voltages relative to the preset voltage. For example, if preset read voltage is one volt (V), then by using dynamic read you may read in steps of +/−100 mV. In other examples, the smallest unit to read may depend on memory type and what it allows. A prefix command and a shift value may be needed and when supplied, the NAND may read at the preset level +/− the shift level, where shift is a signed binary number. The passing case may be when the shift level with which the read passed. The shift may be positive or negative. As discussed above, a negative shift may be used for block 1114, and the amount of the negative shift needed may be retained. The gap or the valley point between the states LM and A may identify the most appropriate place to read the lower page in order to get the least error. Each read may return a number of bits in error or uncorrectable ECC. There may be at least one read that may give fewer bits in error and the dynamic read stops at the first one that is not UECC and uses it.

When a write abort occurs, the recovery procedure may include the detection of the states. The detection may include identifying or manually finding gaps so that the lower page can be read and recovered. In one embodiment, the gap is checked by starting at BR (as shown in FIG. 6) and scanning down to identify the gap or a slight overlap between the LM state and the A state. Further, upper page programming of the A and C states is checked to determine if these states have started programming. When they have started programming, then the upper page cannot be restarted.

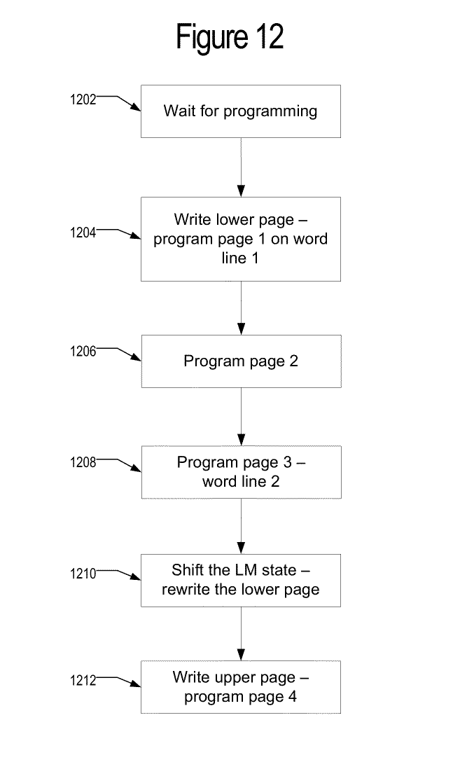

FIG. 12 is a flow chart illustrating the intermediate state shifting. The memory may wait for the programming to be started in block 1202. When the lower page is written in block 1204, the original LM overlaps with the A state when page 1 is programmed. In block 1206, page 2 is then programmed and when page 3 (WL 2) is programmed in block 1208, the coupling-effects may result in the LM being shifted and pushed higher. The LM state may then be rewritten and tightened in block 1210, which eliminates or reduces overlap. When the corresponding upper page is written as page 4 in block 1212, there is limited or no overlap with the rewritten LM state. If the write is aborted during block 1212, the lower page can be successfully read back. The LM adjustment may occur prior to writing the upper page. In one embodiment, the timing of the LM state shifting may start as a background operation before or while the upper page is loaded. In other words, the writing of the upper page in block 1212 may be started while the shifting of the LM state in block 1210 is occurring.

The existing lower page may be read and the verify level and step-size of the LM may be adjusted to reduce overlap before the upper page is written. The normal verify level (for the original LM) is shown along with the shifted verify level (for the new LM) are shown in FIG. 9. The lower page may be rewritten with the distributions narrowed. The upper page may then be written. This implementation for shifting of the LM state may be handled by firmware rather than being an internal operation to the NAND. In one embodiment, the LM shifting operation may be constructed using external command sequences and may not need to be pre-designed. Accordingly, it may be programmed into existing memory devices to improve write abort handling. Further, the operation of shifting the LM state may be aborted and re-started without requiring recovery.

The following tables illustrate exemplary memory blocks that are programmed with the “standard” or “old” programming model, along with memory blocks that are programmed using LM state shifting (“new”) as described above. Each of the memory blocks include a word line (WL), a lower page (Lp), and an upper page (Up). In other words, there is a two bit cell with a lower page and upper page value, which may be implemented as in FIGS. 6-9. As shown in the tables, the number of word lines may vary between 4 and 7 with data stored in the lower page and the upper page for each word line. These tables are merely exemplary and the number of word lines may be decreased or increased.

The following Tables 1 and 2 illustrate the programming of pages 0 to 3 using the standard method. The LM state shifting programming may be applied selectively depending on whether lower page recover may be required. Table 1 illustrates the 6 pages on the lower and upper pages of a particular word line. Table 2 illustrates that the four pages are programmed with the standard programming.

TABLE 1

| WL | L | U |
|---|---|---|
| 0 | 0 | 2 |
| 1 | 1 | 4 |
| 2 | 3 | 6 |
| 3 | 5 | |

TABLE 2

| WL | L | U |
|---|---|---|
| 0 | Standard | Standard |
| 1 | Standard | 4 |
| 2 | Standard | 6 |
| 3 | 5 | |

The next host command may now be for pages 4-6. Utilizing the new (LM shifting or LMB) programming method, pages 4-6 are programmed as illustrated in Tables 3 and 4. Old represents a standard programming scheme. As described, the new LM shifting programming is for programming the upper pages, so the programming of the lower pages may be with standard programming schemes.

TABLE 3

| WL | L | U |
|---|---|---|
| 0 | 0 | 2 |
| 1 | 1 | 4 |
| 2 | 3 | 6 |
| 3 | 5 | |
| 4 | 7 | |

TABLE 4

| WL | L | U |
|---|---|---|
| 0 | Old | Old |
| 1 | Old | New |
| 2 | Old | New |
| 3 | Old | 8 |
| 4 | 7 | |

The next host command may be for programming pages 7 to A. The new LM shifting programming method may be used at the boundaries of the different programming pages. In particular, the new method is used for programming upper pages 4, 6, and 8 because each of those pages are on a boundary with a different programming set. Page A is programmed with the old method because it does not lie on the boundary with a page that has been programmed. As shown in Table 6, page 6 is programmed with LM shifting since it has a pre-existing lower page from the previous page. If the program starts with an upper page, the boundary may be two pages, and if program starts at lower page then the boundary may be just one upper page.

TABLE 6

| WL | L | U |
|---|---|---|
| 0 | Old | Old |
| 1 | Old | New |
| 2 | Old | New |
| 3 | Old | New |
| 4 | Old | Old |
| 5 | Old | C |
| 6 | B | |

TABLE 5

| WL | L | U |
|---|---|---|
| 0 | 0 | 2 |
| 1 | 1 | 4 |
| 2 | 3 | 6 |
| 3 | 5 | 8 |
| 4 | 7 | A |
| 5 | 9 | C |
| 6 | B | |

The following tables illustrate which pages are checked during write abort (“WA”) detection. The detection may be for a write abort at the lower page or a write abort at an upper page. For a write abort at a lower page, the lower page may be good or corrupted. For a write abort at the upper page, the upper page may be good or corrupted. An upper page write abort may also corrupt the lower page of the same word line (“WL”).

WA at Lower Page

| WL | Lower | Upper | Lower | Upper |
|---|---|---|---|---|
| 0 | 0 | 2 | Good (case 0) | Good (case 0) |
| 1 | 1 | 4 | Good (case 0) | Good (case 0) |
| 2 | 3 | 6 | Good (case 0) | Good (case 0) |
| 3 | 5 | 8 | Good (case 0) | FF |
| 4 | 7 | 10 | Good/UECC | FF |
| 5 | 9 | | FF | FF |

| | | | WA at Upper Page | |
|---|---|---|---|---|
| WL | Lower | Upper | Lower | Upper |
| 0 | 0 | 2 | Good (case 0) | Good (case 0) |
| 1 | 1 | 4 | Good (case 0) | Good (case 0) |
| 2 | 3 | 6 | Good/UECC | read as FF(but w/data)/ |
| | | | | UECC/Good |
| 3 | 5 | 8 | Good (case 0) | FF |
| 4 | 7 | 10 | FF | FF |
| 5 | 9 | | FF | FF |

The following tables illustrate a write abort at the upper page at the end of a physical block:

| WL | Lower | Upper | Lower | Upper |
|---|---|---|---|---|
| 125 | 249 | 252 | Good (case 0) | Good (case 0) |
| 126 | 251 | 254 | Good/UECC | read as FF(but w/data)/ |
| | | | | UECC/Good |
| 127 | 253 | 255 | Good (case 0) | FF |

| WL | Lower | Upper | Lower | Upper |
|---|---|---|---|---|
| 125 | 249 | 252 | Good (case 0) | Good (case 0) |
| 126 | 251 | 254 | Good (case 0) | Good (case 0) |
| 127 | 253 | 255 | Good/UECC | read as FF(but w/data)/ |
| | | | | UECC/Good |

As shown above, if the upper page is from word line zero (“WL0”), page 2, then page 0 may be good or from UECC. If the upper page is the middle of the block, for example, page 6 is UECC, then page 3 may be good/UECC, and pages 4-5 should be good. If the upper page is at the end of the block, for example, if page 254 is UECC, then page 251 may be good/UECC, and pages 252-253 should be good. If page 255 is write aborted and UECC, then page 253 may be good/UECC, and page 254 should also be good. When a write aborted page is detected there may be different options as to which data to return. For example, the data to be returned may be new (but subject to UECC), or may be old (but confirmed good), or may be new (and confirmed good).

Before the firmware performs a detailed write abort detection, the initial detection may be for the boundary between the last written page (which may be UECC or good) and the first erased page. The last written page scan may be through a binary search of the physical block. In alternative embodiments, the last written page scan may be determined by moving through a block in steps (e.g. 2 or 4 metapages) attempting to read headers and stopping for any erased. If it is UECC when reading headers, then the process may continue until reaching an erased or good header. Binary search by physical page may check for the first erased page. The search from first erased page to the last ECC page are on same die and if no UECC errors are found during this scan then the process exits. If an error is identified, then the data beyond the first error may be discarded. In general, the system may distinguish if the first FFh page is a lower page or upper page. If the first FFh page is a lower page, it may be identified immediately if it is an erased page. If the first FFh page is an upper page, the system may need to do further checking to confirm if the page is really erased, or if the page contains data by return FFh data due to LM flag misdetection. If an upper page is write aborted, it may still be read as FFh page, as long as the LM byte is not completely programmed. Therefore, there may be additional checking and read points to confirm if a page is write aborted or an erased page. During erase page detection (either with binary search or sequential search), dynamic read may be disabled to avoid misdetection. The write abort detection may include identifying whether a last written page at the boundary is write aborted or not. For the boundary page (the last written page), if it's read as UECC using case 0, the page may be treated as a write aborted page, and writing to the block is not continued. After the copy operation from this block to a new block, the original block may be put back to the pool and will be used after erase. The write abort handling may include a copy operation. After a page is identified as write aborted, the system needs to copy the existing data from the original block to a new location. During such copy operation, dynamic read should be supported.

If an upper page is programmed with LM shifting and a write abort occurs, the lower page from the same wordline (“WL”) may be recovered. In one example, if the upper page program is towards the end when the write abort occurs, the upper page is UECC and the lower page should return good data. No special handling may needed to recover the lower page data. In a second example, if the upper page program is just started or in the middle, the normal read on a lower page (e.g. default BR3 read) may return UECC. The system may need to get into testcode, and use dynamic read to read the level at various BR3 levels. The reading may include shifting down BR3 read level by 100 mV and reading again, until the read returns good data or the read retry reaches a certain number of loops (e.g. 20). Each read retry may be an additional shift of −100 mV. If a particular shift down value of BR3 (for example BR3 shift=200 mV) is used, the lower page read may return good data and it may be recovered. During the copy operation, the firmware may need to know that when it reaches to that page, it may need to enter test mode with setup BR3 shift=200 mV, and it may need use dynamic read to read out the page and write to the new location.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A flash memory device comprising:
a non-volatile storage having an array of memory blocks storing data; and
a controller in communication with the non-volatile storage, the controller is configured for:
writing lower page data on a lower page of the non-volatile storage;
rewriting the lower page data on the lower page by shifting an intermediate level; and
writing to an upper page that corresponds to the lower page after the lower page is rewritten.

2. The device of claim 1 wherein the controller is further configured for:
detecting a write abort condition;
determining whether the lower page data written on the lower page is correct; and
recovering the lower page data.

3. The device of claim 2 wherein the recovering further comprises finding a location of a gap between the intermediate level and another lower level for distinguishing the lower page data.

4. The device of claim 3 wherein the another level comprises an A state and the gap is between the intermediate state and the A state.

5. The device of claim 3 wherein the gap is found using dynamic read.

6. The device of claim 1 wherein the non-volatile storage comprises a multi-level cell (MLC) with multiple programmable levels.

7. The device of claim 6 wherein the intermediate level comprises a lower at middle (LM) level.

8. The device of claim 6 wherein the intermediate level comprises one of the multiple programmable levels.

9. The device of claim 6 wherein the intermediate level transitions into different ones of the multiple programmable levels.

10. A memory system comprising:
a non-volatile storage having an array of memory blocks storing data; and
a controller in communication with the blocks, the controller configured to:
write data to a lower page;
shift a verify level of a lower at middle state;
rewrite the lower page after the shifting; and
write data to an upper page corresponding with the lower page.

11. The memory system of claim 10 wherein the lower at middle state comprises an intermediate state that overlaps with an A state until the verify level is shifted to reduce or eliminate the overlap.

12. The memory system of claim 11 wherein a write abort condition during the write to the upper page does not prevent recovering the data on the lower page.

13. The memory system of claim 12 wherein the lower page data is recovered by detecting a gap between the shifted verify level and the A state.

14. A method for writing to a multiple level cell flash memory comprising:
in a non-volatile storage device having a controller and blocks of memory, the controller:
writing lower page data on a lower page in the memory;
rewriting the lower page data on the lower page by shifting an intermediate level; and
writing to an upper page that corresponds to the lower page after the lower page is rewritten.

15. The method of claim 14 further comprising:
detecting a write abort condition;
determining whether the lower page data written on the lower page is correct; and
recovering the lower page data.

16. The device of claim 15 wherein the recovering further comprises finding a location of a gap between the intermediate level and another lower level for distinguishing the lower page data.

17. The device of claim 16 wherein the another level comprises an A state and the gap is between the intermediate state and the A state.

18. The device of claim 14 wherein the non-volatile storage comprises a multi-level cell (MLC) with multiple programmable levels.

19. The device of claim 18 wherein the intermediate level comprises a lower at middle (LM) level.

20. The device of claim 18 wherein the intermediate level comprises one of the multiple programmable levels.
